(19) United States
(12) Patent Application Publication
(10) Pub. No.: US 2013/0254547 A1
(43) Pub. Date: Sep. 26, 2013

(54) ENCRYPTED TRANSMISSION TO AND STORAGE OF SURPRISAL DATA

(71) Applicant: INTERNATIONAL BUSINESS MACHINES CORPORATION, Armonk, NY (US)

(72) Inventors: Robert R. Friedlander, Southbury, CT (US); James R. Kraemer, Santa Fe, NM (US)

(73) Assignee: International Business Machines Corporation, Armonk, NY (US)

(21) Appl. No.: 13/870,324

(22) Filed: Apr. 25, 2013

Related U.S. Application Data
(63) Continuation-in-part of application No. 13/428,146, filed on Mar. 23, 2012.

(51) Int. Cl. G06F 21/32

(52) U.S. Cl. CPC G06F 21/32
USPC 713/182

(57) ABSTRACT

A method of providing secure access to data representing a genetic sequence of an organism to at least one user requesting access to the data, the user having a private key and a public key related to the private key. The method comprising the steps of: the source computer receiving a request from a user for specific surprisal data and associated metadata; the source computer retrieving the specific surprisal data and associated metadata indicated by the user within the repository; the source computer using the public key of the user to encrypt the specific surprisal data and associated metadata to produce encrypted specific surprisal data and associated metadata; the source computer sending the encrypted specific surprisal data and associated metadata to a repository accessible to the user, the repository having a location indicator for accessing the repository over network; and the source computer sending the location indicator to the user.

### CROSS-REFERENCE TO RELATED APPLICATIONS

This is a continuation-in-part of copending application Ser. No. 13/428,146, filed Mar. 23, 2012, entitled “SURPRISAL DATA REDUCTION OF GENETIC DATA FOR TRANSMISSION, STORAGE, AND ANALYSIS”. The aforementioned application is hereby incorporated herein by reference.

### BACKGROUND

The present invention relates to encryption of data, and more specifically to the encryption and storage of genetic surprisal data.

DNA gene sequencing of a human, for example, generates about 3 billion (3×10⁹) nucleotide bases. Currently, if one wishes to transmit, store or analyze this data, all 3 billion nucleotide base pairs are transmitted, stored and analyzed. The storage of the data associated with the sequencing is significantly large, requiring at least 3 gigabytes of computer data storage space to store the entire genome which includes only nucleotide sequenced data and no other data or information such as annotations. The movement of the data between institutions, laboratories, research facilities, medical offices, and a patient is hindered by the significantly large amount of data and the significant amount of storage necessary to contain the data, Furthermore, the data is private information that needs to be protected from unauthorized users.

Public key cryptography is a cryptography system that uses two separate keys to encrypt data, a public key and a private key. The public key, which can be freely distributed, is related mathematically to the private key. The public key is used to lock or encrypt data or plain text and the private key unlocks or decrypts the encrypted data. Because of the huge number of ways the private key and public key can be related, mere knowledge of the public key is not sufficient to allow decryption, and only the person possessing the private key can therefore decrypt the encrypted data.

### SUMMARY

According to one embodiment of the present invention, a method of providing secure access to data representing a genetic sequence of an organism to at least one user requesting access to the data, the user having a private key and a public key related to the private key. The method comprising the steps of: a source computer comparing nucleotides of the genetic sequence of the organism to nucleotides from a reference genome, to find differences where nucleotides of the genetic sequence of the organism which are different from the nucleotides of the reference genome; the source computer using the differences to create and store surprisal data and associated metadata in a repository, the surprisal data and associated metadata comprising a starting location of the differences within the reference genome, and the nucleotides from the genetic sequence of the organism which are different from the nucleotides of the reference genome, discarding sequences of nucleotides that are the same in the genetic sequence of the organism and the reference genome; the source computer receiving a request from a user for specific surprisal data and associated metadata; the source computer retrieving the specific surprisal data and associated metadata indicated by the user within the repository; the source computer using the public key of the user to encrypt the specific surprisal data and associated metadata to produce encrypted specific surprisal data and associated metadata; the source computer sending the encrypted specific surprisal data and associated metadata to a repository accessible to the user, the repository having a location indicator for accessing the repository over a network; and the source computer sending the location indicator to the user.

According to another embodiment of the present invention, a method of securely accessing data representing a genetic sequence of an organism by a user requesting access to the data, the user having a private key and a public key related to the private key, the surprisal data having been created by the steps of a source computer comparing nucleotides of the genetic sequence of the organism to nucleotides from a reference genome, to find differences where nucleotides of the genetic sequence of the organism which are different from the nucleotides of the reference genome; the source computer using the differences to create and store surprisal data and associated metadata in a repository, the surprisal data and associated metadata comprising a starting location of the differences within the reference genome, and the nucleotides from the genetic sequence of the organism which are different from the nucleotides of the reference genome, discarding sequences of nucleotides that are the same in the genetic sequence of the organism and the reference genome. The method comprising the steps of: the user sending a request to the source computer for specific surprisal data and associated metadata; after the source computer retrieves the specific surprisal data and associated metadata indicated by the user within the repository; and the source computer uses the public key of the user to encrypt the specific surprisal data and associated metadata to produce encrypted specific surprisal data and associated metadata; and the source computer sends the encrypted specific surprisal data and associated metadata to a repository accessible to the user, the repository having a location indicator for accessing the repository over a network; the user receiving the location indicator from the source computer; the user computer using the location indicator to access the encrypted surprisal data and associated metadata; and the user computer decrypting the encrypted surprisal data and associated metadata using the private key of the user.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of encrypting and storing surprisal data for decryption by a user.

FIG. 3 illustrates internal and external components of a client computer and a server computer in which illustrative embodiments may be implemented.

### DETAILED DESCRIPTION

The illustrative embodiments of the present invention recognize that the difference between the genetic sequences from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, 3-5% are functional and influence phenotypic differences between species through alleles. Furthermore that approximately 10 to 30 million SNPs exist in the human population of which at least 1% are functional.

The illustrative embodiments also recognize that with the small amount of differences present between the genetic sequence from two humans, the “common” or “normally expected” sequences of nucleotides can be compressed out or removed to arrive at “surprisal data”-differences of nucleotides which are “unlikely” or “surprising” relative to the common sequences, for example of a filter.

The dimensionality of the data reduction that occurs by removing the “common” sequences is 10³, such that the number of data items and, more important, the interaction between nucleotides, is also reduced by a factor of approximately 10³—that is, to a total number of nucleotides remaining is on the order of 10³.

The illustrative embodiments also recognize that by identifying what sequences are “common” or provide a “normally expected” value within a genome, and knowing what data is “surprising” or provides an “unexpected value” relative to the normally expected value, the only data needed to recreate the entire genome in a lossless manner is the surprisal data and the genome used to obtain the surprisal data.

The illustrative embodiments recognize that a surprisal data filter is a filter associated with the identified characteristics of a generated hierarchy from reference genomes and was created by combining pieces of the reference genomes that match or correspond with identified characteristics. The illustrative embodiments also recognize that surprisal data filter are user specific and are tailored based on user input and a hierarchy of characteristics.

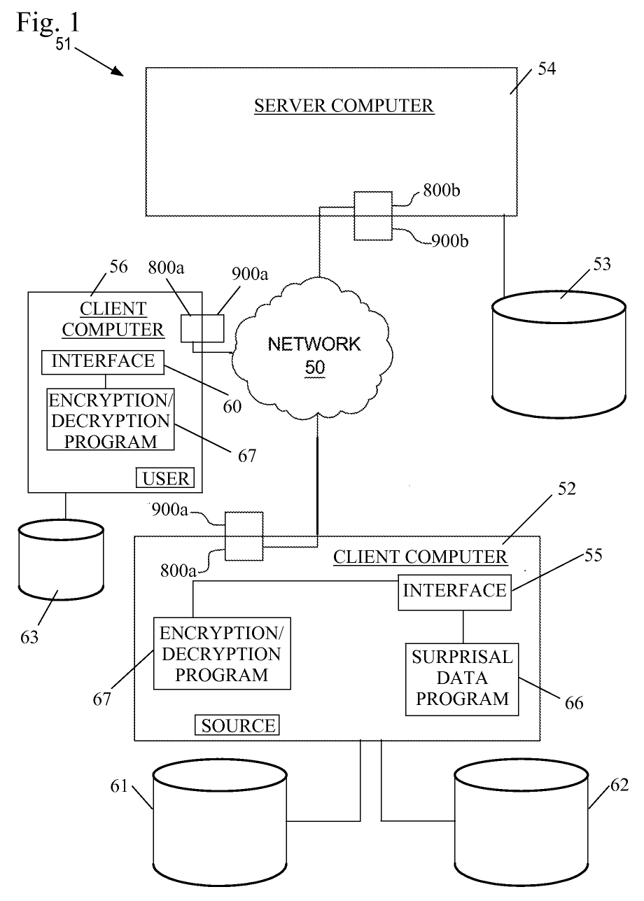

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, a plurality of client computers 52, 56 and a server computer 54 connect to network 50. The server computer 54 is connected to repository 53 and at least one of the client computers 52, used by a source of data, is connected to repository 61 and repository 62. In this embodiment, repository 61 may contain surprisal data and associated metadata. The repository 62 may contain public keys. The repository 53 may contain encrypted surprisal data and associated metadata. It should be noted that the surprisal data and associated metadata may also be stored in the same repository as the public keys.

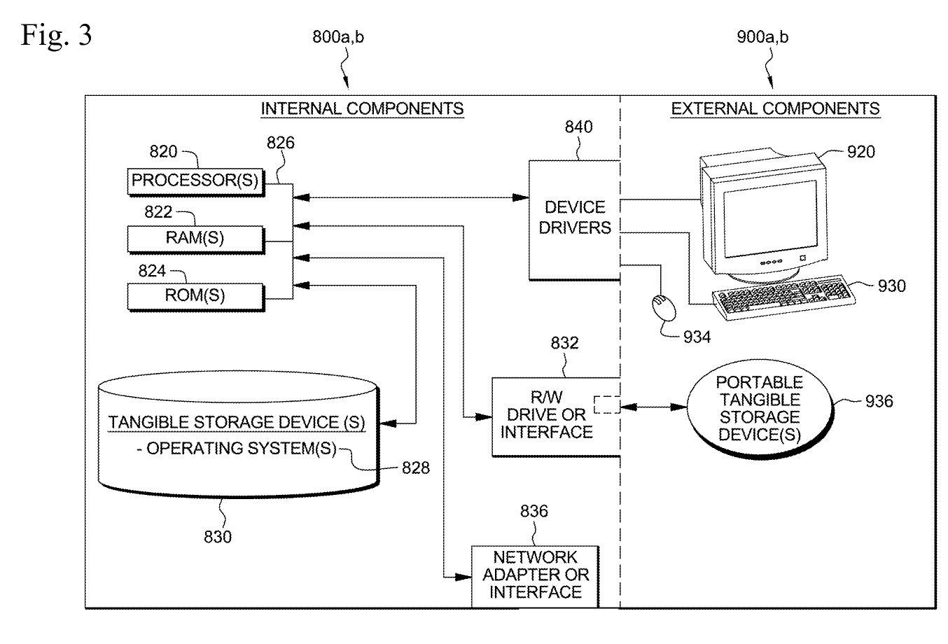

In other exemplary embodiments, network data processing system 51 may include additional client computers, storage devices, server computers, and other devices not shown. The client computers 52, 56 include a set of internal components 800a and a set of external components 900a, further illustrated in FIG. 3. The client computers 52, 56 may be, for example, a mobile device, a cell phone, a personal digital assistant, a netbook, a laptop computer, a tablet computer, a desktop computer, or any other type of computing device.

Client computer 52, for use by the source of data, may contain an interface 55 and client computer 56, an example of a computer for a user of data, may contain an interface 60. The interfaces 55, 60 can be, for example, a command line interface, a graphical user interface (GUI), or a web user interface (WUI). The interfaces 55, 60 may be used, for example for selecting surprisal data filters and/or reference genomes and viewing the surprisal data and associated metadata.

In the depicted example, server computer 54 can provide information, such as boot files, operating system images, and applications to client computers 52, 56, as well as data. Server computer 54 can compute the information locally or extract the information from other computers on network 50. Server computer 54 includes a set of internal components 800b and a set of external components 900b illustrated in FIG. 3 and may also include the components shown in FIG. 3. In this embodiment, the server computer only receives or transmits encrypted hyperlinks to surprisal data and associated metadata.

Program code and programs such as an encryption/decryption program 67 and surprisal data program 66 may be stored on at least one of one or more computer-readable tangible storage devices 830 shown in FIG. 3, on at least one of one or more portable computer-readable tangible storage devices 936 as shown in FIG. 3, or downloaded to a data processing system or other device for use. For example, program code, an encryption/decryption program 67 may be stored on at least one of one or more tangible storage devices 830 on server computer 54 and downloaded to client computers 52, 56 over network 50 for use on client computers 52, 56.

Surprisal data program 66 and encryption/decryption program 67 can be accessed on client computer 52 through interface 55. The encryption/decryption program 67 can be accessed on client computer 56 through interface 60.

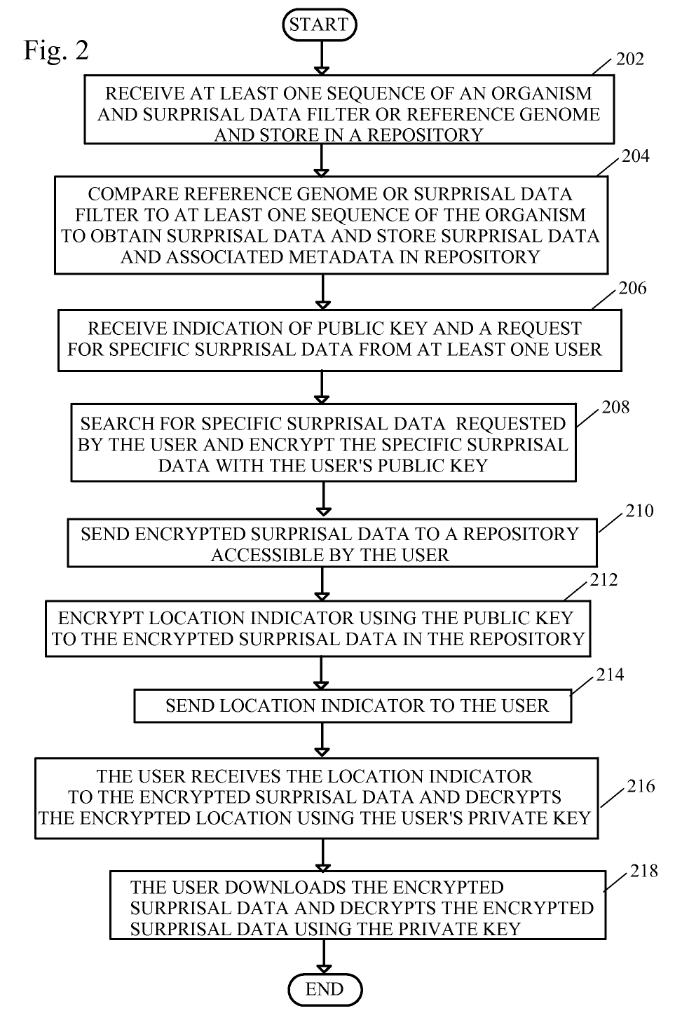

FIG. 2 shows a flowchart of a method of encrypting and storing surprisal data for decryption by a user.

In a first step, at least one uncompressed sequence of an organism and a selected surprisal data filter or reference genome is received by a source, for example client computer 52 and stored in a repository (step 202), for example repository 61. The uncompressed genetic sequence of an organism may be a DNA sequence, an RNA sequence, or a nucleotide sequence and may represent a sequence or a genome of an organism. The organism may be a fungus, microorganism, human, animal or plant.

The surprisal data filter is a filter associated with the identified characteristics of a generated hierarchy from reference genomes and was created by combining pieces of the reference genomes that match or correspond with identified characteristics.

A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes. A surprisal data filter is user specific and tailored reference genome based on user input and hierarchy of characteristics.

The selected surprisal data filter is compared to the at least one sequence of an organism to obtain surprisal data (step 204), for example by the surprisal data program 66. The surprisal data and associated metadata are stored in a repository, for example repository 61 connected to the source, for example client computer 52.

The surprisal data is defined as at least one nucleotide difference that provides an “unexpected value” relative to the normally expected value of the surprisal data filter. In other words, the surprisal data contains at least one nucleotide difference present when comparing the sequence to the surprisal data filter. The surprisal data that is actually stored in the repository preferably includes a location of the difference within the surprisal data filter, the number of nucleotides that are different, and the actual changed nucleotides.

The associated metadata preferably includes an indication of the surprisal data filter or reference genome used, a location of a difference in the surprisal data filter or reference genome, the number of bases that were different at the location within the surprisal data filter or reference genome, and the actual bases that are different than bases in the surprisal data filter at the location.

Client computer 52, a source of the surprisal data, receives a request for specific surprisal data from a user, for example client computer 56 (step 206).

In order for the surprisal data to be encrypted for the user, it is necessary for the user to have generated a public key, which is related to a private key as discussed above. In an exemplary embodiment, the users will send their respective public keys to the source computer 52, and the public keys will be stored in a repository 62, indexed by some identifying information related to the user, for example a user name or password or identification number, etc., as is commonly known in the art. In that embodiment, when a request for data is received, source computer 52 will use the user's identifying information to look up the public key associated with the user 56 in the repository 62. Alternatively, the user computer 56 may send the user's public key to the source computer 52 as part of the request for the encrypted surprisal data.

The source, client computer 52, searches the repository 61 for the specific surprisal data requested by the user, along with any associated metadata, and encrypts the specific surprisal data and metadata with the user's public key (step 208), for example by the encryption/decryption program 67.

The source then sends the encrypted specific surprisal data and any associated metadata to a repository accessible to the user, for example repository 53 (step 210), and the source sends the user a location indicator indicating where the user can find the encrypted specific surprisal data. The location indicator could be, for example, a hyperlink or an internet Uniform Resource Locator (URL) pointing to the data in the repository 53 (step 214).

In a preferred embodiment, between steps 210 and 214, the source 52 encrypts the location indicator to the encrypted specific surprisal data within the repository using the public key (step 212), for example using the encryption/decryption program 67. In this way, no one without the user's private key can even know where the encrypted specific surprisal data resides, much less decrypt it.

The user, for example client computer 56, receives the location indicator to the encrypted specific surprisal data within the repository and, if necessary decrypts the encrypted location indicators using the user's private key (step 216), for example using the encryption/decryption program 67. The user's computer uses the location indicator to download the encrypted specific surprisal data and any associated metadata from the repository 53. The encrypted data can be stored in a local user repository 63, and the user computer 56 can use the user's private key to decrypt the data when it is retrieved so that the user can use the data (step 218). If desired, the local user repository 63 could be a removable or portable data storage device such as a flash drive or other device known to the art.

It should be noted that from the surprisal data and associated metadata, the genome can be recreated by retrieving the reference genome or surprisal data filter indicated within the associated metadata and altering the reference genome or surprisal data based on the surprisal data by replacing nucleotides at each location in the reference genome or surprisal data filter specified by the surprisal data with the nucleotides from the genetic sequence of the organism in the surprisal data associated with the location; resulting in an entire genome of the organism.

FIG. 3 illustrates internal and external components of client computers 52, 56 and server computer 54 in which illustrative embodiments may be implemented. In FIG. 3, client computers 52, 56 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, an encryption/decryption program 67 and a surprisal data program 66 are stored on one or more of the computer-readable tangible storage devices 830 for execution by one or more of the processors 820 via one or more of the RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. An encryption/decryption program 67 and a surprisal data program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. An encryption/decryption program 67 and a surprisal data program 66 can be downloaded to client computer 52 and server computer 54 from an external computer via a network (for example, the Internet, a local area network or other, wide area network) and network adapter or interface 836. From the network adapter or interface 836, an encryption/decryption program 67 and a surprisal data program 66 are loaded into hard drive 830. An encryption/decryption program 67 and can be downloaded to client computer 56 from an external computer via a network (for example, the Internet, a local area network or other, wide area network) and network adapter or interface 836. From the network adapter or interface 836, an encryption/decryption program 67 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

An encryption/decryption program 67 and a surprisal data program 66 can be written in various programming languages including low-level, high-level, object-oriented or non object-oriented languages. Alternatively, the functions of an encryption/decryption program 67 and a surprisal data program 66 can be implemented in whole or in part by computer circuits and other hardware (not shown).

Based on the foregoing, a computer system, method and program product have been disclosed for providing secure access to data representing a genetic sequence of an organism to at least one user requesting access to the data, the user having a private key and a public key related to the private key. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of providing secure access to data representing a genetic sequence of an organism to at least one user requesting access to the data, the user having a private key and a public key related to the private key, the method comprising the steps of:
a source computer comparing nucleotides of the genetic sequence of the organism to nucleotides from a reference genome, to find differences where nucleotides of the genetic sequence of the organism which are different from the nucleotides of the reference genome;
the source computer using the differences to create and store surprisal data and associated metadata in a repository, the surprisal data and associated metadata comprising a starting location of the differences within the reference genome, and the nucleotides from the genetic sequence of the organism which are different from the nucleotides of the reference genome, discarding sequences of nucleotides that are the same in the genetic sequence of the organism and the reference genome;
the source computer receiving a request from a user for specific surprisal data and associated metadata;
the source computer retrieving the specific surprisal data and associated metadata indicated by the user within the repository;
the source computer using the public key of the user to encrypt the specific surprisal data and associated metadata to produce encrypted specific surprisal data and associated metadata;
the source computer sending the encrypted specific surprisal data and associated metadata to a repository accessible to the user, the repository having a location indicator for accessing the repository over a network; and
the source computer sending the location indicator to the user.

2. The method of claim 1, in which the location indicator is a hyperlink.

3. The method of claim 1, further comprising the step of encrypting the location indicator using the public key of the user before sending the location indicator to the user.

4. The method of claim 1, further comprising the steps of:
a user computer receiving the location indicator; and
the user computer using the location indicator to access the encrypted surprisal data and associated metadata.

5. The method of claim 4, further comprising the user computer decrypting the encrypted surprisal data and associated metadata using the private key of the user.

6. The method of claim 4, in which the method further comprises:
the source computer encrypting the location indicator using the public key of the user to produce an encrypted location indicator, before sending the encrypted location indicator to the user computer; and
the user computer decrypting the encrypted location indicator using the private key of the user, to derive the location indicator.

7. The method of claim 1 in which the source computer comprises a public key repository storing public keys associated with users, and the method further comprises the step of looking up the public key of the user in the public key repository.

8. A method of securely accessing data representing a genetic sequence of an organism by a user requesting access to the data, the user having a private key and a public key related to the private key, the surprisal data having been created by the steps of a source computer comparing nucleotides of the genetic sequence of the organism to nucleotides from a reference genome, to find differences where nucleotides of the genetic sequence of the organism which are different from the nucleotides of the reference genome; the source computer using the differences to create and store surprisal data and associated metadata in a repository, the surprisal data and associated metadata comprising a starting location of the differences within the reference genome, and the nucleotides from the genetic sequence of the organism which are different from the nucleotides of the reference genome, discarding sequences of nucleotides that are the same in the genetic sequence of the organism and the reference genome; the method comprising the steps of:
the user sending a request to the source computer for specific surprisal data and associated metadata;
after the source computer retrieves the specific surprisal data and associated metadata indicated by the user within the repository; and the source computer uses the public key of the user to encrypt the specific surprisal data and associated metadata to produce encrypted specific surprisal data and associated metadata; and the source computer sends the encrypted specific surprisal data and associated metadata to a repository accessible to the user, the repository having a location indicator for accessing the repository over a network; the user receiving the location indicator from the source computer;
the user computer using the location indicator to access the encrypted surprisal data and associated metadata; and
the user computer decrypting the encrypted surprisal data and associated metadata using the private key of the user.

9. The method of claim 8, in which the location indicator is a hyperlink.

10. The method of claim 8, in which the location indicator was encrypted using the public key of the user before sending the location indicator to the user, and the method further comprises the step of decrypting the location indicator using the private key of the user.

11. The method of claim 8, further comprising the step of the user sending the public key of the user to the source computer.
